(19) United States
(12) Patent Application Publication
(10) Pub. No.: US 2023/0140634 A1
(43) Pub. Date: May 4, 2023

(54) MULTI-CONVOLUTIONAL TWO-DIMENSIONAL ATTENTION UNIT FOR ANALYSIS OF A MULTIVARIABLE TIME SERIES THREE-DIMENSIONAL INPUT DATA

(71) Applicant: UNIVERSIDADE DO PORTO, Porto (PT)

(72) Inventors: Rui Jorge PEREIRA GONÇALVES, Proto (PT); Fernando Manuel FERREIRA LOBO PEREIRA, Proto (PT); Vítor Miguel DE SOUSA RIBEIRO, Porto (PT)

(21) Appl. No.: 18/010,501

(22) PCT Filed: Nov. 27, 2020
(86) PCT No.: PCT/IB2020/061241

§ 371 Date: Dec. 15, 2022

(30) Foreign Application Priority Data
Jun. 15, 2020 (PT) 116495

(51) Int. Cl. G06N 3/02

(52) U.S. Cl. CPC G06N 3/02; G06N 3/08

(57) ABSTRACT

It is therefore an object of the present invention a multi-convolutional two-dimensional (2D) attention unit to be applied in performing MTS three-dimensional (3D) data analysis, of input data (1) with cyclic properties, using an RRN architecture. This unit is able to constructs one independent attention vector a per variable of the MTS using 2D convolutional operations to capture the importance of a time-step inside surrounding segments and time-steps area. For that purpose, the two-dimensional attention unit is comprised by a splitting block (2), a attention block (3), a concatenation block (4) and a scaling block (5).

### FIELD OF THE INVENTION

The present invention is enclosed in the field of Recurrent Neural Networks. In particular, the present invention relates to attention mechanisms applicable to perform Multivariable Time-Series analysis with cyclic properties, using Recurrent Neural Networks.

### PRIOR ART

Attention is a mechanism to be combined with Recurrent Neural Networks (RNN) allowing it to focus on certain parts of the input sequence when predicting a certain output, forecast or classify the sequence, enabling easier learning and of higher quality. Combination of attention mechanisms enabled improved performance in many tasks making it an integral part of modern RNNs.

Attention was originally introduced for machine translation tasks, but it has spread into many other application areas. On its basis, attention can be seen as a residual block that multiplies the result with its own input hᵢ and then reconnects to the main Neural Network (NN) pipeline with a weighted scaled sequence. These scaling parameters are called attention weights aᵢ and the result is called context weights cᵢ for each value i of the sequence, i.e. all together, are called context vector c of sequence size n. This operation is given by:

$${c}_{i} = {\sum }_{i = 0}^{n} {α}_{i} {h}_{i}$$

Computation of aᵢ is given by applying a softmax activation function to the input sequence x^{l} on layer l:

$${α}_{i} = \frac{exp ( {x}_{i}^{l} )}{{\sum }_{k}^{n} ( {x}_{k}^{l} )}$$

This means that the input values of the sequence will compete with each other to receive attention, knowing that, the sum of all values obtained from the softmax activation is 1, the scaling values in the attention vector a will have values between [0,1].

The attention mechanism can be applied before or after recurrent layers. If attention is applied directly to the input, before enter into a RNN, it is called attention before, otherwise, if it is applied to a RNN output sequence, it is called attention after.

In case of Multivariate Time-Series (MTS) input data, a bidimensional dense layer is used to perform attention, which is subject to permutation operations before and after this layer, so the attention mechanism can be applied between values inside each sequence and not between each time step of all sequences.

A two-dimensional convolutional recurrent layer was proposed by Chen et al. [1]. The work motivation was to predict future rainfall intensity based on sequences of meteorological images. Applying these layers in a NN architecture they were able to outperform state-of-the-art algorithms for this task. Two-dimensional convolutional layers are recurrent layers, just like any other recurrent layer, such as Long Short-Term Memory (LSTM), but where internal matrix multiplications are exchanged with convolution operations. As a result, the data that flows through said two-dimensional convolutional layers cells allows to keep the three-dimensional characteristics of the input MTS data (Segments×Time-Steps×Variables) instead of being just a two-dimensional map (Time-Steps×Variables).

Solutions exist in the art where, such as the case of U.S. Pat. No. 9,830,709B2, which discloses a method for video analysis with convolutional attention recurrent neural network. This method includes generating a current multi-dimensional attention map. The current multi-dimensional attention map indicates areas of interest in a first frame from a sequence of spatiotemporal data. The method further includes receiving a multi-dimensional feature map and convolving the current multi-dimensional attention map and the multidimensional feature map to obtain a multi-dimensional hidden state and a next multi-dimensional attention map. The method identifies a class of interest in the first frame based on the multi-dimensional hidden state and training data.

Document US2018/144208A1 discloses a spatial attention model that uses current hidden state information of a decoder LSTM to guide attention and to extract spatial image features for use in image captioning.

Document CN109919188A discloses a time sequence classification method based on a sparse local attention mechanism and a convolutional echo state network.

As a conclusion, all the existing solutions seems to be silent on any adaptations required to an attention mechanism of an RNN architecture, which is applied to the specific case of analysing MTS data with cyclic properties, to achieve a more accurate analysis.

The present solution intended to innovatively overcome such issues.

### SUMMARY OF THE INVENTION

It is therefore an object of the present invention a multi-convolutional two-dimensional (2D) attention unit to be applied in performing MTS three-dimensional (3D) data analysis with cyclic properties, using an RRN architecture. It is also an object of the present invention a method of operation of the multi-convolutional 2D attention unit. This unit is able to constructs one independent attention vector a per variable of the MTS using 2D convolutional operations to capture the importance of a time-step inside surrounding segments and time-steps area. Many-sub patterns can be analysed using staked 2D convolutional layers inside the attention block.

In another object of the present invention it is described a processing system adapted to perform MTS 3D data analysis with cyclic properties, which comprises the 2D attention unit now developed.

### DESCRIPTION OF FIGURES

FIG. 1—block diagram representation of an embodiment of the Multi-Convolutional 2D Attention Unit developed with wherein the reference signs represent:
1—MTS 3D input data;
2—Splitting block;
3—2D Attention block;
4—Concatenation block;
5—Scaling block.

FIGS. 2 and 3—block diagram representations of two embodiments of a processing system configured to perform analysis on MTS data with cyclic properties, wherein the reference signs represent:
1—MTS 3D input data;
2—Splitting block;
3—2D Attention block;
4—Concatenation block;
5—Scaling block;
6—RNN with 2D convolutional layers;
7—Dense layer;
   Wherein, in FIG. 2 is represented the embodiment of the processing system where the 2D Attention Unit is applied before the RNN with 2D convolutional layers, and, in FIG. 3, is represented the embodiment of the processing system where the 2D Attention Unit is applied after the RNN with 2D convolutional layers.

FIG. 4—representation of a padding mechanism in segments dimension inside the 2D Attention Unit.

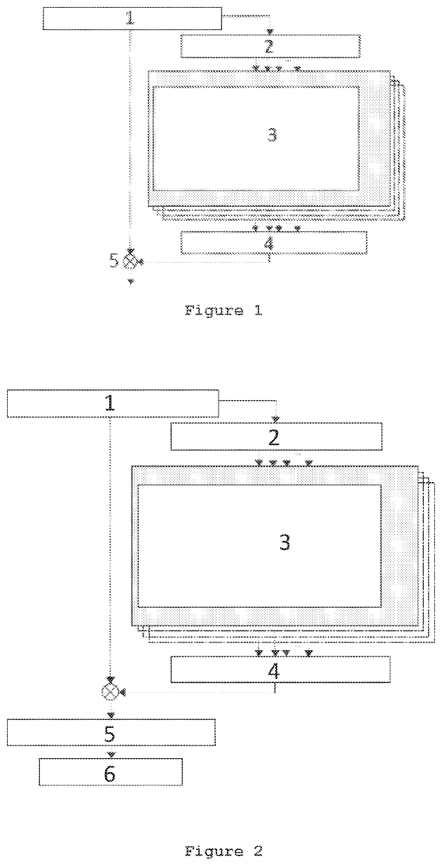

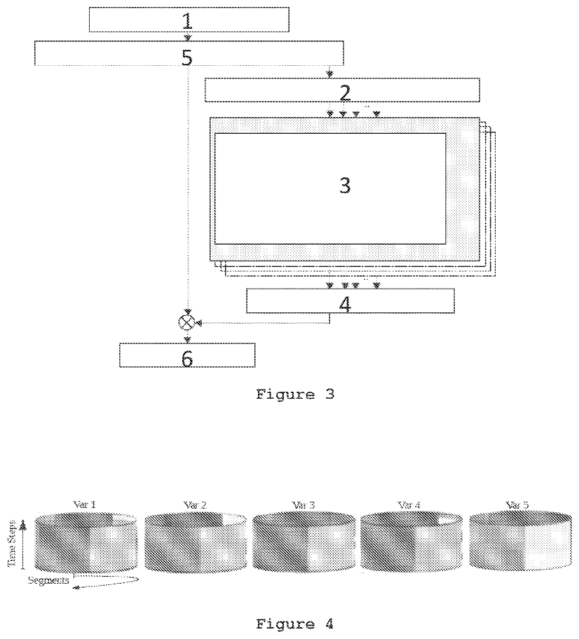

### DETAILED DESCRIPTION

The more general and advantageous configurations of the present invention are described in the Summary of the invention. Such configurations are detailed below in accordance with other advantageous and/or preferred embodiments of implementation of the present invention.

It is described a multi-convolutional 2D attention unit specially developed for performing MTS 3D data analysis (1), using RNN (6) architectures. The MTS 3D input data (1) is split into individual time series and for each sequence is created a path with 2D convolutional layers and the result is concatenated again. FIG. 1 illustrates only one filter convolution per sequence i.e. per variable of the MTS input data (1), if attention is before the RRN (6) as illustrated in FIG. 2, or per Number of Filters generated by the RRN, if attention block is applied after, as illustrated in FIG. 3.

Inside the 2D attention block, each path contains a 3D feature map information for each variable with: segments×filter number×time-steps. The first step is to permute the filter number dimension with the segment dimension so it is possible to feed RNN (6) that will learn 2D kernels that correlate segments and variables. To these 2D maps, it is possible to apply a padding mechanism in the dimension of the segment. This is useful for time-series that exhibit cyclic properties. E.g. if the segments represent days and the time-steps are divided by 24 hours a 2D kernel will capture attention patterns relating some hours of the day and also the same period in the days before and after. Moreover, if one has segments of 7 days, one can use a padding mechanism in the dimension of the segment so the border processing, by the kernel, can correlate the first day of the week with the last day of the week if the data tends to have a strong weekly cycle. The last convolution layer must use the softmax activation function so the information inside each resulting map competes for attention. This will maintain (Σᵢ₌₀ⁿΣⱼ₌₀^{m}a_{i,j})=1, important for competitive weighting values of each 2D map per channel (Segment i×time-step j). In resume, the last output must use the softmax activation so each value has a scaling factor in [0,1] range and all sum to 1.

Before the concatenate operation the dimensions are permuted back to the original order and each path returns a 3D map with the same format (segments×filter number×time-steps) as received in the input of the attention block. These maps are concatenated with each other result in a 4D feature map of attention weights, a, with format: segments×filter number×time-steps×variables. This map is compatible for multiplication with h to obtain the 4D context map c, as in the classical attention. This 4D context map has scaling values in the segments and time-steps dimension for each filter number and variable.

The main advantage provided by the 2D attenuation block now developed relies on instead of processing individual steps, it is possible to process areas of attention in the segments and time-steps dimension, according to its neighbour's values i.e. sub-pattern in the time series. The importance of each area of attention will compete with all others in the same traditional way, using the softmax activation. Since each original sequence/time series variable of the MTS input will be scaled individually, each time series variable is processed individually. Thus, a split operation is applied to create a 2D attention block for each individual variable of the MTS. Before scaling the inputs, with the matrix multiplication, all obtained attention 3D maps are concatenated resulting in a compatible 4D matrix. In this way, it is constructed one independent attention vector a per variable of the MTS using 2D convolutional operations to capture the importance of a time-step inside surrounding segments and time-steps area. Many-sub patterns can be analysed using staked convolutional 2D layers inside the attention block.

### Embodiments

The object of the present invention is a multi-convolutional 2D attention unit for performing analysis of a MTS 3D input data (1). For the purpose of the present invention the MTS 3D input data (1) is defined in terms of segments×time-steps×variables, having cyclic properties is suitable for being partitioned into segments.

The multi-convolutional 2D attention unit comprises the following block: a splitting block (2), a attention block (3), a concatenation block (4) and a scaling block (5).

The splitting block (2) comprising processing means adapted to convert the 3D input data (1) into a 2D feature map of segments×time-steps for each metric. The metric can be variables of the 3D input data (1) or the number of recursive cells generated by RNN (6) according to if the unit is applied before or after a RNN (6), respectively. The purpose of the split operation is to create an attention “block” for each individual variable in the MTS 3D input data (1). Since each variable of the original sequence of the MTS 3D input data (1) will be scaled individually, each variable of the input data (1) will be processed individually.

The attention block (3) comprising processing means adapted to implement a 2D convolutional layer. Said 2D convolutional layer comprising at least one filter and a softmax activation function. The attention block is configured to apply the 2D convolutional layer to the 2D feature map, extracted from the splitting block (2) in order to generate a path containing a three-dimensional feature map information for each metric—variables or recursive cell number—with: segment×filter number×time-step. By using a 2D convolutional layer inside the attention block (3), it is possible to give attention to a time-step according to its neighbor's values and neighbor segments−time-steps×segments, allowing to extract the importance of each time-step taking into consideration the context of the contiguous time-steps and the time-steps in the same temporal area of contiguous segments. Therefore, the importance of each variable taken inside a sub-pattern, will compete with all others in the same traditional way, using the softmax activation. The attention block (3) further comprises processing means adapted to implement a permute operation configured to permute two dimensions in a three-dimensional feature map. More particularly, such permute operation is used to bring segments back to the first dimension, just like the original input data (1). The concatenation block (4) is configured to concatenate the 3D feature map outputted by the attention block (3), to generated a 4D feature map of attention weights, a, segments×filter numbers×time-steps×variables. A scaling block (5) configured to multiply the three-dimensional input data (1) with the four-dimensional feature map of attention weights, a to generate a context map, c.

In one embodiment of the multi-convolutional 2D attention unit developed, it is applied before a RNN (6), and wherein:
the metric is variables of the input data (1);
such input data (1) is applied directly to the splitting block (2); and
the number of filters of the 2D convolutional layer of the recursive block (3) is equal to the number of variables of the input (1).

In another embodiment of the multi-convolutional 2D attention unit developed, it is applied after a RNN (6), and wherein:
the metric is number of recursive cells generated in the RNN (6);
the input (1) feeds the RNN (6);
the splitting block (2) is adapted to split the output of the RNN (6) into a number of recursive cells generated sequences; and
the number of filters of the two-dimensional convolutional layer of the recursive block (3) is equal to the number recursive cells generated by the RNN (6).

In another embodiment of the multi-convolutional 2D attention unit developed, the 2D convolution layer of the attention block (2) is programmed to operate according to a one-dimensional kernel parameter. Alternatively, the 2D convolution layer of the attention block (2) is programmed to operate according to a two-dimensional kernel parameter.

In another embodiment of the multi-convolutional 2D attention unit developed, the permutation operation executed in the attention block (3) is configured to permute the filter number dimension with the segment dimension and/or the segment dimension with the filter number dimension.

In another embodiment of the multi-convolutional 2D attention unit developed, the attention block (3) is further configured to implement a padding mechanism to the path containing the 3D feature map information generated by the 2D convolutional layer.

It is another object of the present invention, a processing system for performing analysis of a MTS 3D input data (1), defined in terms of segments×time-step×variables, comprising:
processing means adapted to implement a RNN (6);
the multi-convolutional two-dimensional attention unit developed.

In one embodiment of the processing system, the multi-convolutional 2D attention unit is applied before the RNN (6). Alternatively, multi-convolutional 2D attention unit is applied after the RNN (6).

In one embodiment of the processing system, the RNN (6) is Long Short-Term Memory.

Finally, it is an object of the present invention, a method of operating the multi-convolutional 2D attention unit developed, comprising the following steps:

i. Converting a MTS 3D input data (1), defined in terms of segments×time-steps×variables, into a two-dimensional feature map of segments×time-steps;

ii. Applying a 2D convolutional layer to the 2D feature map in order to generate a path containing a 3D feature map information for each metric with: segments×filter number×time-steps;

iii. Applying a permute function to the 3D feature map information in order to permute filter number dimension with the segment dimension resulting in a 3D feature map of filter number×segments×time-steps;

iv. Repeat the steps ii. and iii. for all filters of the 2D convolutional layer and apply a softmax activation function to the last convolutional layer in order to maintain (Σᵢ₌₀ⁿΣⱼ₌₀^{m}a_{i,j})=1, for competitive weighting values of each 2D feature map per filter number: segment i×time-step j;

v. Applying a permute function to permute back to the original order of the path's 3D feature map information for each metric: segments×filter numbers×time-steps;

vi. Concatenating each path's 3D feature map information resulting in a 4D feature map of attention weights a, with format: segments×filter numbers×time-steps×variables;

Wherein the metric corresponds to:
a number of variables of the input (1) in case the 2D attenuation block is applied before a RNN (6); or
a number of recursive cells generated by a RNN (6) if the 2D attenuation block is applied after said RNN (6).

In one embodiment of the method, the correlation between segments is performed configuring the 2D convolutional layer of the attention block (3) to have a 2D kernel.

In another embodiment of the method, a padding mechanism is applied to the segments dimension of the path's 3D feature map information prepared by the 2D convolutional layer of the attention block (3).

As will be clear to one skilled in the art, the present invention should not be limited to the embodiments described herein, and a number of changes are possible which remain within the scope of the present invention.

Of course, the preferred embodiments shown above are combinable, in the different possible forms, being herein avoided the repetition all such combinations.

### Experimental Results

As an example, we present the results from a case study related to the individual household electric power consumption. This dataset is provided by the UCI machine learning repository [2]. One is focused on MTS classification, and so it is provided results comparisons between Deep Learning methodologies using accuracy and categorical cross-entropy metrics. As target value the average level of the global house active power consumption for the next 24 hours, in five classes, based on the last 168 hours i.e. 7 days. One uses a sliding window of 24 hours. Each time-step is one hour of data. The five classes to predict are levels from very low (level 0) to very high (level 4). The time series will have representative patterns for every day of the weak that can be grouped and contained in a 2D map.

TABLE 1
Simple LSTM:
Accuracy: 37.70%

| | precision | recall | f1-score | support |
|---|---|---|---|---|
| 0 | 0.5000 | 0.6957 | 0.5818 | 115 |
| 1 | 0.3333 | 0.4286 | 0.3750 | 140 |
| 2 | 0.4815 | 0.0922 | 0.1548 | 141 |
| 3 | 0.3488 | 0.2778 | 0.3093 | 108 |
| 4 | 0.2750 | 0.4783 | 0.3492 | 69 |
| Avg/total | 0.3991 | 0.3991 | 0.3468 | 573 |

TABLE 2
LSTM with standard attention:
Accuracy: 40.70%

| | precision | recall | f1-score | support |
|---|---|---|---|---|
| 0 | 0.6442 | 0.5826 | 0.6119 | 115 |
| 1 | 0.3799 | 0.4789 | 0.4237 | 140 |
| 2 | 0.4110 | 0.2143 | 0.2817 | 141 |
| 3 | 0.3185 | 0.4630 | 0.3774 | 108 |
| 4 | 0.3065 | 0.2714 | 0.2879 | 69 |
| Avg/total | 0.4198 | 0.4070 | 0.4015 | 573 |

TABLE 3
LSTM with Multi-convolutional attention:
Accuracy: 42.06%

| | precision | recall | f1-score | support |
|---|---|---|---|---|
| 0 | 0.6481 | 0.6087 | 0.6278 | 115 |
| 1 | 0.3486 | 0.5429 | 0.4246 | 140 |
| 2 | 0.4222 | 0.2695 | 0.3290 | 141 |
| 3 | 0.3750 | 0.3333 | 0.3529 | 108 |
| 4 | 0.3443 | 0.3043 | 0.3231 | 69 |
| Avg/total | 0.4313 | 0.4206 | 0.4161 | 573 |

TABLE 4
Simple LSTM with 2D-convolutional layers:
Accuracy: 42.41%

| | precision | recall | f1-score | support |
|---|---|---|---|---|
| 0 | 0.5966 | 0.6174 | 0.6068 | 115 |
| 1 | 0.3644 | 0.5857 | 0.4493 | 140 |
| 2 | 0.5610 | 0.1631 | 0.2527 | 141 |
| 3 | 0.3542 | 0.4722 | 0.3529 | 108 |
| 4 | 0.3636 | 0.2319 | 0.2832 | 69 |
| Avg/total | 0.4574 | 0.4241 | 0.4042 | 573 |

TABLE 5
LSTM with 2D-convolutional layers with multi-convolutional
2D attention block with padding mechanism in segments dimension:
Accuracy: 43.11%

| | precision | recall | f1-score | support |
|---|---|---|---|---|
| 0 | 0.5940 | 0.6870 | 0.6371 | 115 |
| 1 | 0.3653 | 0.4357 | 0.3974 | 140 |
| 2 | 0.4148 | 0.3972 | 0.4058 | 141 |
| 3 | 0.4253 | 0.3426 | 0.3795 | 108 |
| 4 | 0.2745 | 0.2029 | 0.2333 | 69 |
| Avg/total | 0.4237 | 0.4311 | 0.4244 | 573 |

### REFERENCES

[1]—Xingjian Shi, Zhourong Chen, Hao Wang, Dit-Yan Yeung, Wai kin Wong, and Wang
chun Woo. Convolutional lstm network: A machine learning approach for
precipitation nowcasting, 2015.
[2]—Alice Berard Georges Hebrail. Individual household electric power consumption Data Set, November 2010. http://archive.ics.uci.edu/ml/datasets/Individual+household+electric+power+consumption.

1. Multi-convolutional two-dimensional attention unit for performing analysis of a multivariable time series three-dimensional input data (1), defined in terms of segments×time-steps×variables; the unit characterized by comprising:
A splitting block (2) comprising processing means adapted to convert the three-dimensional input data (1) into a two-dimensional feature map of segments×time-step for each metric, the metric being the variables of the input data (1) or the number of recursive cells generated by recursive neural network (6);
A attention block (3) comprising processing means adapted to implement a two-dimensional convolutional layer comprising at least one filter and a softmax activation function; the attention block (3) being configured to apply the two-dimensional convolutional layer to the two-dimensional feature map in order to generate a path containing a three-dimensional feature map information for metric with: segments×filter number×time-steps;
The attention block (3) further comprising processing means adapted to implement a permute operation configured to permute two dimensions in a three-dimensional feature map;
A concatenation block (4) configured to concatenate the three-dimensional feature map outputted by the attention block (3), to generated a four-dimensional feature map of attention weights, a;
A scaling block (5) configured to multiply the three-dimensional input data (1) with the four-dimensional feature map of attention weights, a, to generate a context map, c.

2. Multi-convolutional two-dimensional attention unit according to claim 1, wherein the multi-convolutional two-dimensional attention unit is applied before a recursive neural network (6), and wherein:
The metric is variables of the input data (1);
The input data (1) is applied directly to the splitting block (2); and
the number of filters of the two-dimensional convolutional layer of the recursive block (3) is equal to the number of variables of the input (1).

3. Multi-convolutional two-dimensional attention unit according to claim 1, wherein the multi-convolutional two-dimensional attention unit is applied after a recursive neural network (6), and wherein:
The metric is number of recursive cells, generated by the recursive neural network (6);
The input data (1) feeds the recursive neural network (6);
The splitting block (2) is adapted to split the output of the recursive neural network (6) into a number of recursive cells generated sequences;
the number of filters of the two-dimensional convolutional layer of the attention block (3) is equal to the number recursive cells generated by the recursive neural network (6).

4. Multi-convolutional two-dimensional attention unit according to claim 1, wherein the two-dimensional convolution layer of the attention block (3) is programmed to operate according to a one-dimensional kernel parameter.

5. Multi-convolutional two-dimensional attention unit according to claim 1, wherein the two-dimensional convolution layer of the attention block (3) is programmed to operate according to a two-dimensional kernel parameter.

6. Multi-convolutional two-dimensional attention unit according to claim 1, wherein the permutation operation executed in the attention block (3) is configured to permute the filter number dimension with the segment dimension and/or the segment dimension with the filter number dimension.

7. Multi-convolutional two-dimensional attention unit according to claim 1, wherein the attention block (3) is further configured to implement a padding mechanism to the path containing the three-dimensional feature map information generated by the two-dimensional convolutional layer.

8. Processing system for performing analysis of a multivariable time series three-dimensional input data (1), defined in terms of segments×time-step×variables, comprising:
processing means adapted to implement a recursive neural network (6);
the multi-convolutional two-dimensional attention unit of claim 1.

9. Processing system according to claim 8, wherein the multi-convolutional two-dimensional attention unit is applied before the recursive neural network (6).

10. Processing system according to claim 8, wherein the multi-convolutional two-dimensional attention unit is applied after the recursive neural network (6).

11. Processing system according to claim 8, wherein the recursive neural network (6) is Long Short-Term Memory.

12. Method of operating the multi-convolutional two-dimensional attention unit of claim 1, comprising the following steps:
i. Converting a multivariable time series three-dimensional input data (1), defined in terms of segments×time-steps×variables, into a two-dimensional feature map of segments×time-steps;
ii. Applying a two-dimensional convolutional layer to the two-dimensional feature map in order to generate a path containing a three-dimensional feature map information for each metric with: segments×filter number×time-steps;
iii. Applying a permute function to the three-dimensional feature map information in order to permute filter number dimension with the segment dimension resulting in a three-dimensional feature map of filter number×segments×time-steps;
iv. Repeat the steps ii. and iii. for all filters of the two-dimensional convolutional layer and apply a softmax activation function to the last convolutional layer in order to maintain (Σᵢ₌₀ⁿΣⱼ₌₀^{m}a_{i,j})=1, for competitive weighting values of each two-dimensional feature map per filter number: segment i×time-step j;
v. Applying a permute function to permute back to the original order of the path's three-dimensional feature map information for each metric: segments×filter numbers×time-steps;
vi. Concatenating each path's three-dimensional feature map information resulting in a four-dimensional feature map of attention weights a, with format: segments×filter numbers×time-steps×variables;
Wherein the metric corresponds to:
a number of variables of the input (1) in case the two-dimensional attenuation block is applied before a recursive neural network (6); or
a number of recursive cells generated by a recursive neural network (6) if the two-dimensional attenuation block is applied after said recursive neural network (6).

13. Method according to previous claim 12, wherein the correlation between segments is performed configuring the two-dimensional convolutional layer of the attention block (3) to have a two-dimensional kernel.

14. Method according to claim 12, wherein a padding mechanism is applied to the segments dimension of the path's three-dimensional feature map information prepared by the two-dimensional convolutional layer of the attention block (3).
